(19) United States
(12) Patent Application Publication
(10) Pub. No.: US 2013/0087936 A1
(43) Pub. Date: Apr. 11, 2013

(54) WATER VAPOR TRANSPORT MEMBRANE

(71) Applicants: Annette M. Brenner, Honeoye Falls, NY (US); Timothy J. Fuller, Pittsford, NY (US); Lijun Zou, Rochester, NY (US)

(72) Inventors: Annette M. Brenner, Honeoye Falls, NY (US); Timothy J. Fuller, Pittsford, NY (US); Lijun Zou, Rochester, NY (US)

(73) Assignee: GM GLOBAL TECHNOLOGY OPERATIONS LLC, Detroit, MI (US)

(21) Appl. No.: 13/253,212

(22) Filed: Oct. 5, 2011

(51) Int. Cl. B01F 3/04; F24F 3/14; B05D 3/02

(52) U.S. Cl. 261/100; 427/384; 261/104; 261/107

(57) ABSTRACT

A water vapor transport membrane for a membrane humidifier and a method for making the water vapor transport membrane are described.

### BACKGROUND OF THE INVENTION

The invention relates to a fuel cell and more particularly to a membrane humidifier for a fuel cell.

Electrochemical conversion cells, commonly referred to as fuel cells, produce electrical energy by processing first and second reactants, e.g., through oxidation and reduction of hydrogen and oxygen. By way of illustration and not limitation, a typical polymer electrolyte fuel cell comprises a polymer membrane (e.g., a proton exchange membrane) that is positioned between a pair of catalyst layers with a pair of gas diffusion media layers outside the catalyst layers. A cathode plate and an anode plate are positioned at the outermost sides adjacent the gas diffusion media layers, and the preceding components are tightly compressed to form the cell unit.

The voltage provided by a single cell unit is typically too small for useful applications. Accordingly, a plurality of cells are arranged and connected consecutively in a “stack” to increase the electrical output of the electrochemical conversion assembly or fuel cell. The fuel cell stack typically uses bipolar plates between adjacent MEAs.

In order to perform with the desired efficiency, the polymer membrane needs to be moist. Consequently, it is sometimes necessary to provide humidification to maintain the needed moisture level. This helps to avoid damage to the membrane and the resulting shortened life, as well as to maintain the desired efficiency of operation. For example, a lower water content in the membrane leads to higher proton conduction resistance, resulting in a higher ohmic voltage loss. The humidification of the feed gases, in particular the cathode inlet, is desirable in order to maintain sufficient moisture in the membrane, especially in the inlet region. Humidification in fuel cells is discussed in commonly owned U.S. Pat. Nos. 7,036,466, and 7,572,531, and U.S. patent application Ser. No. 10/912,298, entitled “Humidifier Bypass System and Method for PEM Fuel Cell,” filed Aug. 5, 2004, Ser. No. 61/447212, entitled “Separator Roll Membrane Coating for Fuel Cell Humidifier,” filed Feb. 28, 2011, each of which is hereby incorporated herein by reference in its entirety.

Air humidifiers are frequently used to humidify the air stream used in the fuel cell in order to maintain the desired moisture level, as described in U.S. Pat. Nos. 6,471,195, and 7,156,379, each of which is hereby incorporated herein by reference in its entirety.

Membrane humidifiers have also been used to maintain needed moisture levels. For the automotive fuel cell humidification application, a membrane humidifier needs to be compact, exhibit low pressure drop, and have high performance characteristics. FIG. 1 illustrates one embodiment of a membrane humidifier assembly 10 for a fuel cell (not shown). The membrane humidifier assembly 10 includes a wet plate 12 and a dry plate 14. The membrane humidifier assembly 10 for a cathode side of the fuel cell is described. However, it is understood that the membrane humidifier assembly 10 can be used for the anode side of the fuel cell, or otherwise, as desired.

The wet plate 12 includes a plurality of flow channels 16 formed therein. The channels 16 are adapted to convey a wet gas from the cathode of the fuel cell to an exhaust (not shown). A land 18 is formed between adjacent channels 16 in the wet plate 12.

The dry plate 14 includes a plurality of flow channels 20 formed therein. The channels 20 are adapted to convey a dry gas from a source of gas (not shown) to the cathode of the fuel cell. A land 22 is formed between adjacent channels 20 in the dry plate 14.

Any conventional material can be used to form the wet plate 12 and the dry plate 14, such as steel, polymers, and composite materials, for example.

As used herein, wet gas means a gas such as air and gas mixtures of O₂, N₂, H₂O, and H₂, for example, including water vapor and/or liquid water therein at a level above that of the dry gas. Dry gas means a gas such as air and gas mixtures of O₂, N₂, H₂O, and H₂, for example, absent water vapor or including water vapor and/or liquid water therein at a level below that of the wet gas. It is understood that other gases or mixtures of gases can be used as desired.

A diffusion medium or diffusion layer 24 is disposed adjacent the wet side plate 12 and abuts the lands 18 thereof. Similarly, a diffusion medium or diffusion layer 26 is disposed adjacent the dry side plate 14 and abuts the lands 22 thereof. The diffusion media 24, 26 are formed from a resilient and gas permeable material such as wovens or non-wovens of carbon, polymer, and glass fibers for example.

A membrane 28 is disposed between the diffusion medium 24 and the diffusion medium 26. The membrane 28 can be any conventional membrane such as perfluorosulfonic acid (PFSA) (e.g., Nafion® available from DuPont), hydrophilic polymer membranes, and polymer composite membranes, for example. For a compact fuel cell humidifier application, the membrane 28 will generally have a beginning of life permeance of greater than about 8,000 gas permeation units (GPU) (GPU is a partial pressure normalized flux where 1 GPU=10⁻⁶ cm³ (STP)/(cm² sec cm Hg)), and typically in the range of about 10,000-12,000 GPU for a 25 m homogeneous Nafion®.

The water vapor transfer is measured using a 50 cm² membrane area, and straight flowfields with a similar geometry to that shown in U.S. Pat. No. 7,875,396, counter flow, with a dry side flow of 11.5 slpm, 80C, 183 kPaa, and wet side flow of 10 slpm, 80° C., 85% relative humidity, and 160 kPaa.

### SUMMARY OF THE INVENTION

One aspect of the invention is a method of making a water vapor transport membrane. In one embodiment, the method includes diluting a PFSA ionomer dispersion with a solvent; combining a layer of the diluted PFSA ionomer dispersion with a membrane support layer; and drying the PFSA layer forming the water vapor transport membrane, the water vapor transport membrane having a beginning of life water vapor transfer of at least about 12,000 GPU, wherein the substrate is a backer and removed.

Another aspect of the invention is a water vapor transport membrane for a membrane humidifier. In one embodiment, the water vapor transport membrane consists essentially of a single layer of PFSA ionomer; a layer of expanded poly(tetrafluoroethylene) (ePTFE) wet laminated on the ionomer layer; wherein the water vapor transport membrane has a beginning of life water vapor transfer of at least about 12,000 GPU.

### BRIEF DESCRIPTION OF THE DRAWINGS

FIG. 1 illustrates one embodiment of a membrane humidifier assembly for a fuel cell.

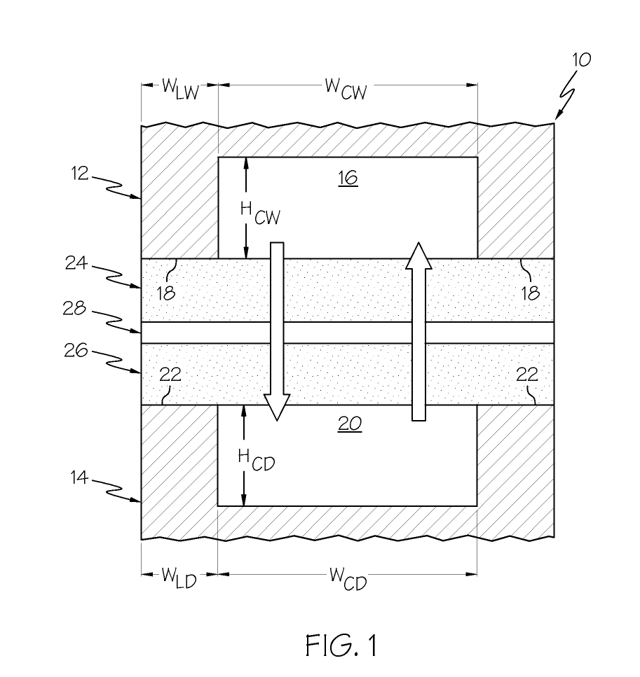

FIG. 2 is a graph showing the water permeability of various membranes as a function of run time.

### DETAILED DESCRIPTION OF THE INVENTION

A leak-free, water vapor transport (WVT) membrane with a beginning of life water vapor transfer of 20,000 GPU has been developed. Therefore, the membrane can maintain the desired 16,000 GPU over the life of the membrane in spite of water transfer degradation. Higher permeance allows the humidifier to be smaller. Alternatively, it permits more membrane degradation while still maintaining the needed water vapor transfer.

The desired beginning of life water vapor transfer depends on the system the material is being used in and the conditions under which it operates. Not all systems need a beginning of life water vapor transfer of 20,000 GPU. Consequently, WVT membranes having a beginning of life water vapor transfer lower than 20,000 GPU are usable in a variety of systems.

An aqueous dispersion of Aquivion® D70-20BS (available from Solvay-Solexis) is used. Aquivion® D70-20BS is a short side chain PFSA-based ionomer with a 700 EW. The aqueous dispersion is typically about 20 wt % solids in water. The aqueous dispersion of Aquivion® D70-20BS is diluted with a solvent. The diluted PFSA ionomer dispersion is combined with a layer of ePTFE. In one embodiment, the diluted dispersion is coated on a backer material, and the ePTFE layer is wet laminated on the coating. In another embodiment, the coating is deposited on a substrate including ePTFE. The coating is then dried. In some embodiments, the substrate is removed, leaving the membrane made of the ionomer and the ePTFE.

The coating can be dried at any suitable temperature for any suitable length of time, for example, in the range of room temperature to about 80° C. Optionally, the dried coating can then be heated at a temperature in a range of about 80° C. to about 250° C. for a time in a range of about 1 hr for lower temperatures to about 1 min for higher temperatures.

The substrate can be a backer material which is removed after the coating is dried. The backer material can be any clean material that allows easy release of the membrane. Suitable materials include, but are not limited to, polymers coated with fluorinated ethylene-propylene copolymers or PTFE.

Alternatively, the substrate could be a membrane support layer. The ionomer layer could be deposited directly on the membrane support layer. In this case, the substrate would not need to be removed. Suitable membrane support layers include, but are not limited to ePTFE layers, and ePTFE bonded to papers.

Suitable solvents include, but are not limited to, isopropanol and N,N-dimethylacetamide (DMAc).

The ePTFE layer is generally about 10 to about 30 microns thick, but it can collapse down to about 5 to about 20 microns when in contact with the dispersion.

The ionomer layer is generally less than about 10 microns, or less than about 7 microns, or less than about 5 microns, or less than about 4 microns.

### EXAMPLE 1

Membranes were made with different perfluorosulfonic acid (PFSAs) ionomers using the method described below. The PFSA ionomers were Nafion® DE2020 (available from DuPont), Aquivion® 85-15 (available from Solvay-Solexis), and Aquivion® D70-20BS (available from Solvay-Solexis),

An aqueous dispersion of the Aquivion® D70-20BS PFSA ionomer (20 wt %) was diluted with isopropanol or DMAc to 15, 12.5, 10, and 5 wt % solids. This dispersion was coated onto fluorinated ethylene-propylene (FEP)-coated polyimide film backer material (e.g., Kapton® 120FN616, 1 mil available from DuPont), and overlaid with ePTFE. The composite was dried on a heated platen or in an oven at 50° C., and then heated in an oven at 80° C. for 1 hr.

The backer was removed, and the water vapor transport of the resultant WVT membrane was then tested.

The ionomer dispersion was coated onto the backer material using a 3-mil Bird applicator. Other coating methods could be also used including, but not limited to, reverse roll coating, and slot die coating.

Membranes were also made from ionomer dispersions diluted with DMAc and which included 30 wt. % poly(vinylidene fluoride) (e.g., Kynar® Flex available from Arkema). The poly(vinylidene fluoride) can be used to improve the durability of the membrane. However, the water vapor transfer performance of the membranes with poly(vinylidene fluoride) was lower than those without it.

The membranes made with DMAc (at 5 wt. % solids) had lower water vapor transfer performance compared with the membrane made with Aquivion® D70-20BS diluted with isopropanol (5 wt % solids). In addition, the membranes made with DMAc needed a break-in period to remove the DMAc solvent.

The ePTFE became clear as it imbibed the isopropanol or DMAc at solids levels of 15, 12.5, 10 and 5 wt. %. At 5 wt. % solids, the ePTFE support became opaque white when the solvent evaporated, indicating that the ePTFE was not completely imbibed with the ionomer solution. The color change is believed to be due to the liquid solvent filling the ePTFE support resulting in transparency. If the ePTFE support remains clear after drying (solvent removal), the ionomer has imbibed into the ePTFE support.

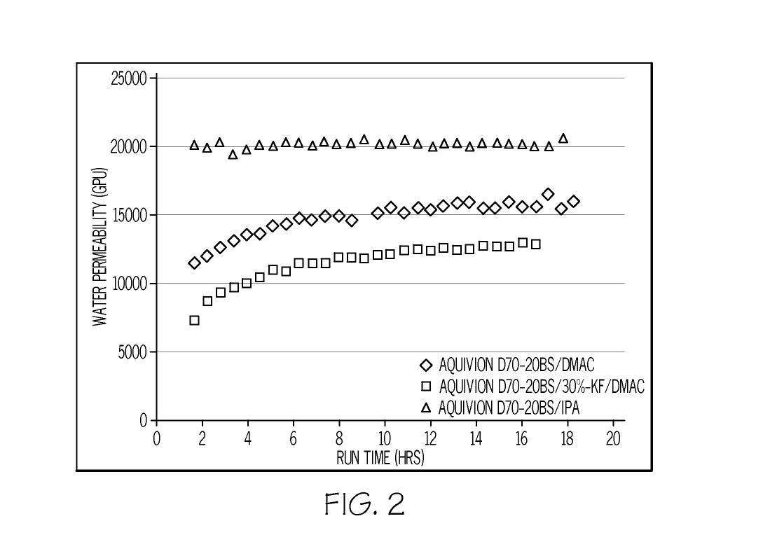

The WVT membrane made with Aquivion® D70-20BS and diluted to 5 wt. % solids with isopropanol had a water vapor transport of 20,000 GPU as shown in FIG. 2.

The WVT membrane desirably has a beginning of life water vapor transport of at least about 12,000 GPU, or at least about 13,000 GPU, or at least about 14,000 GPU, or at least about 15,000 GPU, or at least about 16,000 GPU, or at least about 17,000 GPU, or at least about 18,000 GPU, or at least about 19,000 GPU, or at least about 20,000 GPU. Beginning of life indicates the performance within the first twenty hours following any break-in period.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components. For example, a “device” according to the present invention may comprise an electrochemical conversion assembly or fuel cell, a vehicle incorporating an electrochemical conversion assembly according to the present invention, etc.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A method of making a water vapor transport membrane comprising:
diluting a PFSA ionomer dispersion with a solvent;
combining a layer of the diluted PFSA ionomer dispersion with a membrane support layer; and
drying the PFSA layer forming the water vapor transport membrane, the water vapor transport membrane having a beginning of life water vapor transfer of at least about 12,000 GPU.

2. The method of claim 1 wherein the PFSA ionomer is a short side chain PFSA-based ionomer having an equivalent weight of about 700.

3. The method of claim 1 wherein the PFSA ionomer is a short side chain PFSA-based ionomer having an equivalent weight of about 700, wherein the PFSA ionomer dispersion contains about 20 wt % solids dispersed in water, wherein the PFSA ionomer dispersion is diluted to about 5 wt % solids by the solvent, and wherein the solvent is isopropanol.

4. The method of claim 1 wherein the PFSA ionomer dispersion contains about 20 wt. % solids dispersed in water.

5. The method of claim 1 wherein the PFSA ionomer dispersion is diluted to about 5 wt. % solids by the solvent.

6. The method of claim 1 wherein the solvent is isopropanol or N,N-dimethylacetamide.

7. The method of claim 1 wherein the PFSA ionomer dispersion further comprises poly(vinylidene fluoride).

8. The method of claim 1 wherein combining the layer of the diluted PFSA ionomer dispersion with the membrane support layer comprises:
coating the layer of the diluted PFSA ionomer dispersion on a backer material;
placing the membrane support layer on the layer of the diluted PFSA ionomer dispersion; and
removing the backer material after the PFSA layer is dried.

9. The method of claim 1 wherein combining the layer of the diluted PFSA ionomer dispersion with the membrane support layer comprises:
coating the layer of the diluted PFSA ionomer dispersion on the membrane support layer.

10. The method of claim 1 wherein the membrane support layer is ePTFE or ePTFE bonded to paper.

11. The method of claim 1 wherein the water vapor transport membrane has a beginning of life water vapor transfer of at least about 15,000 GPU.

12. The method of claim 1 wherein the water vapor transport membrane has a beginning of life water vapor transfer of at least about 17,000 GPU.

13. The method of claim 1 wherein the water vapor transport membrane has a beginning of life water vapor transfer of at least about 19,000 GPU.

14. The method of claim 1 wherein the PFSA layer is dried at a temperature within the range of about room temperature to about 80° C.

15. The method of claim 1 further comprising heating the dried water vapor transport membrane.

16. The method of claim 15 wherein the water vapor transport membrane is heated at a temperature in a range of about 80° C. to 250° C.

17. A water vapor transport membrane for a membrane humidifier consisting essentially of:
a single layer of PFSA ionomer;
a layer of ePTFE on the ionomer layer; and
wherein the water vapor transport membrane has a beginning of life water vapor transfer of at least about 12,000 GPU.

18. The water vapor transport membrane of claim 17 wherein the PFSA ionomer is a short side chain PFSA-based ionomer having an equivalent weight of about 700.

19. The water vapor transport membrane of claim 17 further comprising a percentage of poly(vinylidene fluoride).

20. The water vapor transport membrane of claim 17 wherein the water vapor transport membrane has a beginning of life water vapor transfer of at least about 15,000 GPU.

21. The water vapor transport membrane of claim 17 wherein the water vapor transport membrane has a beginning of life water vapor transfer of at least about 17,000 GPU.

22. The water vapor transport membrane of claim 17 wherein the water vapor transport membrane has a beginning of life water vapor transfer of at least about 19,000 GPU.

23. The water vapor transport membrane of claim 17 wherein the PFSA ionomer is a short side chain PFSA-based ionomer having an equivalent weight of about 700 and wherein the water vapor transport membrane has a beginning of life water vapor transfer of at least about 15,000 GPU.
